(19) United States
(12) Patent Application Publication
(10) Pub. No.: US 2010/0021252 A1
(43) Pub. Date: Jan. 28, 2010

(54) DEVICE FOR POWER DRILLS

(75) Inventor: Paul Leckey, Allambie Heights (AU)

Correspondence Address: CONNOLLY BOVE LODGE & HUTZ LLP, 1875 EYE STREET, N.W., SUITE 1100, WASHINGTON, DC, 20006, US

(73) Assignee: INVENTIONS UNLIMITED NO. 4 PTY LIMITED

(21) Appl. No.: 12/306,418

(22) PCT Filed: Jul. 4, 2007
(86) PCT No.: PCT/AU2007/000923

§ 371 Date: Aug. 27, 2009

(30) Foreign Application Priority Data
Jul. 5, 2006 (AU) 2006903609

(51) Int. Cl. B23B 47/00; B25D 17/14

(52) U.S. Cl. 408/67

(57) ABSTRACT

A dust collection device for use with a drill which consists of a an open ended receptacle having one end dimensioned to sealingly engage the boss of the drill bit and the other end including an orifice sized to allow the drill bit to pass through there being a dust adhesive a wettable sponge attached to the external face surrounding the orifice. The sponge surface is pressed against the substrate to be drilled and the drill bit passes through the orifice and sponge. Drill dust is collected in the receptacle and the drilled hole is wiped with the sponge to collect the remaining dust.

This invention relates to a dust collector for use with power drills.

### BACKGROUND TO THE INVENTION

When using a power drill the dust created by the drill falls to the ground and becomes creates a hazard and dirt which needs to be cleaned up after the drilling is finished. Most attempts to collect the dust during the drilling operation have not been successful or are quite expensive.

The most popular technique is to remove the dust using a vacuum line.

U.S. Pat. No. 4,064,952 is an early example. The drill bit passes through a chamber connected to a vacuum line and the chamber is held against the substrate being drilled. U.S. Pat. Nos. 4,192,390 and 4,207,953 which use the same general principle but with a telescoping arrangement to allow for travel of the bit into the substrate.

The evolution of this approach can be seen in U.S. Pat. Nos. 5,090,499, 6,887,146, 6,951,439, 7,017,680 and pending application 20040251041. This approach is only partially effective and is quite expensive. The design fails to collect the dust that is attached to the drill bit and which is generally spilled as the bit is withdrawn from the hole.

Simple collection devices without a vacuum line have also been proposed.

U.S. Pat. No. 3,776,647 uses a pair of telescoping cones to act as a guard and a dust collector.

U.S. Pat. No. 3,936,213 has a chamber adjacent the end of the bit and a collapsible support to allow travel of the bit into the substrate.

U.S. Pat. No. 4,921,375 uses a concertina cone and an extraction fan on the drill.

U.S. Pat. No. 5,419,663 uses an axially compressible collection chamber.

U.S. Pat. No. 5,765,654 discloses a spring biased version.

U.S. Pat. No. 6,102,631 is directed to a dust receptacle with internal vanes that fits over a drill bit.

Each of these uses a collection device that is secured to the drill chuck.

It is an object of this invention to provide a simple and inexpensive method to collect dust from power drills.

### BRIEF DESCRIPTION OF THE INVENTION

To this end the present invention provides a dust collection device for use with a drill which consists of a an open ended receptacle having one end dimensioned to sealingly engage the boss of the drill bit and the other end including an orifice sized to allow the drill bit to pass through, there being a flexible dust adhesive surface attached to the external face surrounding the orifice.

The advantage of this combination is that the dust which is withdrawn with the drill bit is wiped past the dust adhesive surface so that all dust is collected. The dust adhesive surface is conveniently a sponge that can be wet before the drilling is commenced. The device is held in one hand, the drill bit passed through the receptacle and its orifice so that the receptacle seals about the drill boss. After the hole is drilled the drill bit is with drawn from the hole and through the receptacle so that the dust is collected in the receptacle and on the dust adhesive surface. The dust adhesive surface can be washed or wiped clean and the receptacle emptied into a waste bin.

The device is inexpensive to make and does not require attachment to the drill boss.

### DETAILED DESCRIPTION OF THE INVENTION

A preferred embodiment will now be described with reference to the drawings in which:

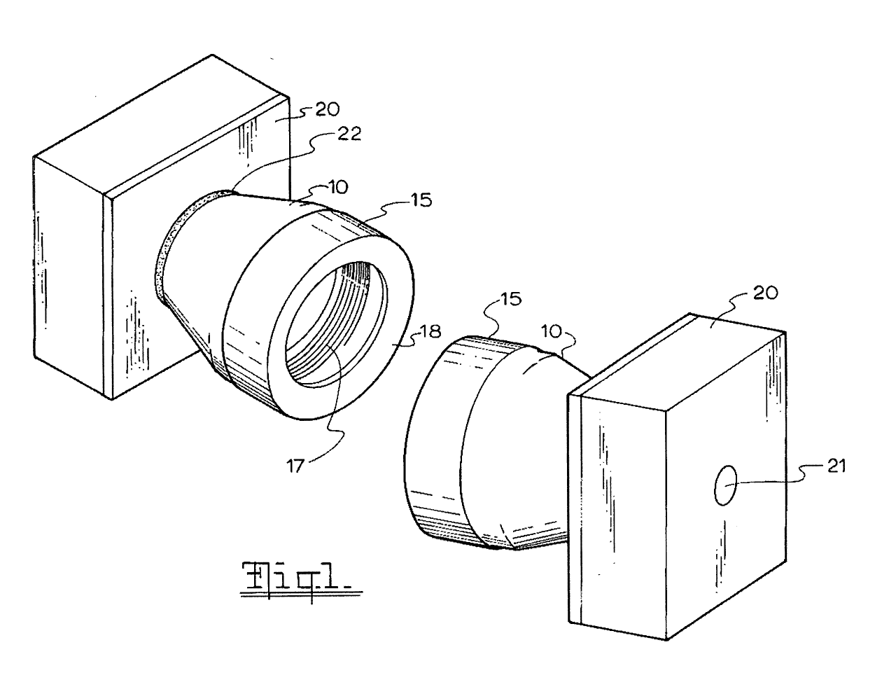

FIG. 1 are two perspective views of the dust receptacle of this invention;

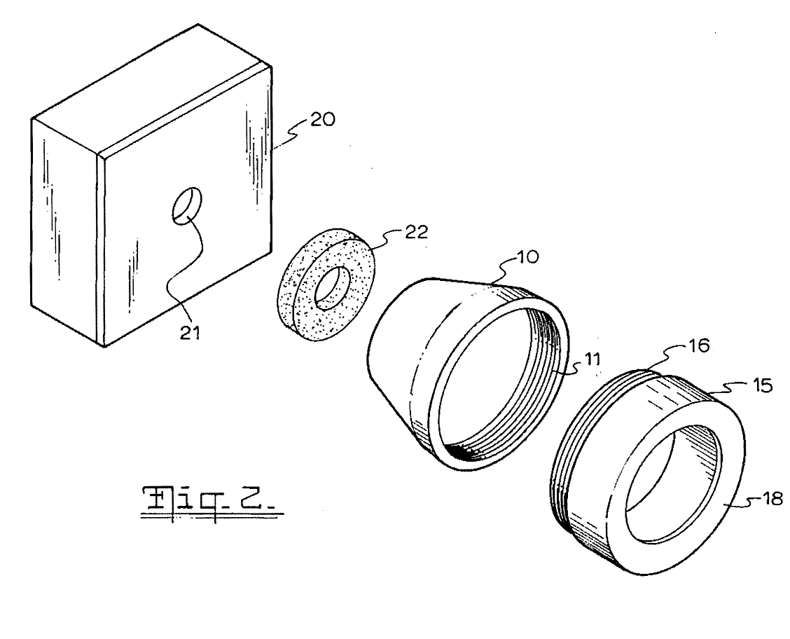

FIG. 2 is an exploded view of the receptacle of FIG. 1;

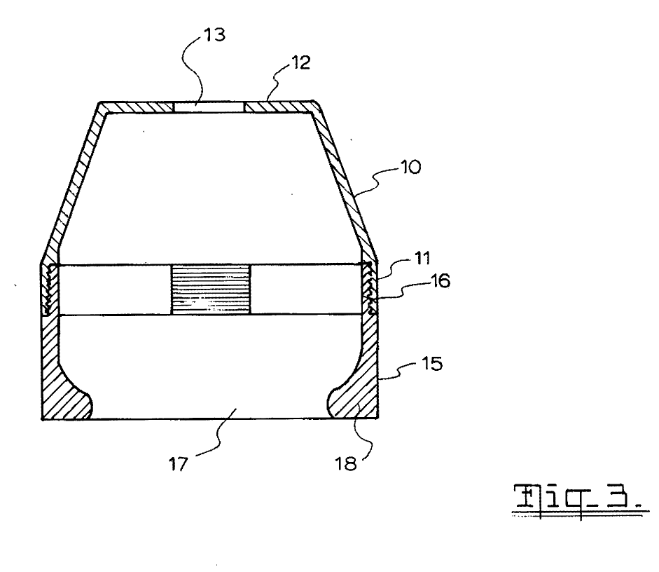

FIG. 3 is a side sectional view of the body portion shown in FIG. 1.

The dust receptacle consists of conical body 10 and a cylindrical portion 15 which in this embodiment are connectable by complementary screw threads 11 and 16. The two portions may of course be formed in one piece or may be attachable by other means such as a snap fitting. The portion 15 has a large opening 17 defined by the deep lip 18. The conical portion 10 has a flat end 12 with a hole 13 for the drill bit to pass through. The dust adhesive device is preferably a foam sponge 20 with a hole 21 aligned with the hole 13 of portion 10, adhered temporarily by non stick adhesive or Velcro annular disc 22 to the end face 12.

The operational sequence is:
1. The sponge 20 is wet and attached to the receptacle end face 12;
2. The device is held in one hand and the power drill in the other hand;
3. the device is placed over the drill bit with only the tip showing through the hole 13;
4. the device is pressed against the substrate to be drilled so that the sponge 20 is pressed against the surface of the substrate;
5. The power drill is operated and the drill bit passes through holes 13 and 21 (directing drill dust into the receptacle) until the drill chuck abuts the lip 18 of opening 17;
6. The device is held against the substrate while the drill bit is withdrawn;
7. the devices sponge 20 is used to wipe the surface around the drilled hole to collect any remaining dust;
8. the receptacle is emptied into a bin and the sponge washed if desired.

The device is now ready for the next hole to be drilled.

The device is held horizontally or vertically downward to ensure that the dust is not spilt from the receptacle. The lip 13 is sized to reduce the possibility of that occurring.

The receptacle 10,15 can be moulded from any suitable plastic material and is preferably transparent. The sponge material can be any suitable wettable cleaning sponge material.

From this description it can be seen that this invention provides a simple to make and simple to use device which is more effective and less expensive than the prior art devices.

Those skilled in the art will realize that this invention can be implemented in a number of visually different embodiments without departing from the core teachings of this invention.

1. A dust collection device for use with a drill which consists of a an open ended receptacle having one end dimensioned to sealingly engage the boss of the drill bit and the other end including an orifice sized to allow the drill bit to pass through there being a flexible dust adhesive surface attached to the external face surrounding the orifice.

2. A dust collection device as claimed in claim 1 in which the dust adhesive surface is a wettable sponge.
